(19) United States
(12) Patent Application Publication
(10) Pub. No.: US 2018/0268474 A1
(43) Pub. Date: Sep. 20, 2018

(54) SKETCH-BASED BID FRAUD DETECTION

(71) Applicant: Amobee, Inc., Redwood City, CA (US)

(72) Inventors: Adam Lugowski, Redwood City, CA (US); Daniel Liu, Cupertino, CA (US); Ruixin Yang, Sunnyvale, CA (US); Jin-Cheng Chen, Sunnyvale, CA (US); Arjun Satish, Foster City, CA (US)

(73) Assignee: Amobee, Inc., Redwood City, CA (US)

(21) Appl. No.: 15/461,113

(22) Filed: Mar. 16, 2017

(51) Int. Cl. G06Q 30/08; G06Q 30/02

(52) U.S. Cl. CPC G06Q 30/08; G06Q 30/0275

(57) ABSTRACT

According to various embodiments, techniques and mechanisms described herein facilitate the identification of fraudulent request messages. In one example, a request message associated with a user identifier is received at a request server in a request system that includes a plurality of such request servers. An estimated message count value associated with the user identifier is identified. The estimated message count value identifies an estimated number of messages associated with the user identifier that were previously received by the request servers. A response message is transmitted when it is determined that the estimated message count is below a designated threshold.

### TECHNICAL FIELD

The present disclosure relates generally to fraudulent message detection and more specifically to the detection of fraudulent requests to bid on opportunities in a real-time auction framework.

### DESCRIPTION OF RELATED ART

Many websites, mobile device applications (apps), and video sites use programmatic ads, where the ad to display is chosen by a real-time auction. When a user visits a page or app screen in which an ad is to be located, an advertisement request message is transmitted to a real-time auction platform. The auction platform in turn transmits an advertising opportunity bid request to some number of demand-side platforms (DSPs) that each have an opportunity to bid for the ad impression. The winner bidder can then transmit an advertisement for presentation to the user.

Evaluating whether to bid on a request presents significant logistical and computational challenges for a DSP. A DSP may receive bid requests from hundreds of millions of unique users every day and may receive millions of bid requests every second. Because the ad auctions are conducted in real time, the DSP may need to respond to a bid request in a fraction of a second to have a chance at winning the auction. In order to handle this volume and to respond in an appropriate amount of time, the DSP may divide the requests among hundreds of servers.

Many of the advertising opportunity bid requests are fraudulent, and a variety of techniques are employed both within DSPs and third-party fraud detection services to detect these fraudulent requests. Detecting fraud provides for more efficient services and higher returns by avoiding the expenditure of money and computing resources analyzing and bidding on fraudulent bid requests that have no potential of leading to the sale of a product or other advertisement conversion event. One type of fraudulent request is transmitted based on visits by programs known as bot users that suddenly appear, transmit a large number of bid requests in a short period of time, and then quickly disappear without transmitting further requests.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms, techniques, and computer readable media having instructions stored thereon for identifying fraudulent requests. According to various embodiments, a request message may be received via a network interface at a designated request server in a request system. The request system may a plurality of request servers that include the designated request server. The request message may be associated with a designated user identifier. A processor may identify an estimated message count value associated with the user identifier. The estimated message count value may identify an estimated number of messages associated with the user identifier and previously-received by the plurality of request servers. A response message may be transmitted via the network interface when it is determined that the estimated message count is below a designated threshold.

In particular embodiments, the request message may identify an opportunity to place a bid on an advertisement impression, and the response message may include advertisement impression bid information indicating a bid to place on the identified advertisement impression bid opportunity. The request message may be evaluated to determine whether to bid on the advertisement impression when it is determined that the estimated message count is below a designated threshold, and the response message may be transmitted when a determination is made to bid on the advertisement impression.

In particular embodiments, determining the estimated message count value may include determining a plurality of hash values associated with the user identifier, where each of the plurality of hash values is associated with a respective hash function. A plurality of hash count values each associated with a respective hash value and a respective hash function may also be identified. Each hash count value may identify a number of times the respective hash value has been previously computed via the respective hash function. The plurality of hash count values may be combined into a single value, for instance by determining a minimum of the plurality of hash count values.

In some implementations, a plurality of local hash count value totals may be updated based on the plurality of hash values. Updating the plurality of local hash count value totals may involve incrementing each local hash count value total that corresponds with a respective one of the plurality of hash values and a respective one of the plurality of hash functions. A global hash count value update message including the local hash count value totals may be transmitted to an aggregation service. The aggregation service may respond with a global hash count value response message that includes a plurality of global hash count value totals corresponding with the local hash count value totals, with each global hash count value total identifying a number of times that a designated hash value has been determined for a designated hash function across the plurality of request servers.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates an example of a bid request processing system, configured in accordance with one or more embodiments.

FIG. 2 illustrates an example of a bid count sketch, arranged in accordance with one or more embodiments.

FIG. 3 illustrates an example of a bid request processing method, performed in accordance with one or more embodiments.

FIG. 4 illustrates an example of a request server global sketch updating method, performed in accordance with one or more embodiments.

FIG. 5 illustrates an example of a aggregation service global sketch updating method, performed in accordance with one or more embodiments.

FIG. 6 illustrates an example of a computing device, configured in accordance with one or more embodiments.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular techniques and mechanisms related to advertising campaigns. However, it should be noted that the techniques and mechanisms of the present invention apply to a variety of different computing techniques and mechanisms. In the following description, numerous specific details are set forth in order to provide a thorough understanding of the present invention. Particular example embodiments of the present invention may be implemented without some or all of these specific details. In other instances, well known process operations have not been described in detail so as not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, techniques and mechanisms described herein may facilitate the detection of fraudulent request messages. According to various embodiments, bid request processing may be divided among a number of request servers. Each request server may maintain data that facilitates the estimation of the number of bid request messages associated with a designated user identifier that have been received on the request server. Data generated by different request servers may be periodically aggregated at an aggregation service. The aggregated data may then be sent back to the request server. By using the aggregated data, the request server may then estimate how many bid request messages associated with the designated user identifier have been received across all of the request servers reflected in the aggregation.

### Example Embodiments

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost-effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers determine a bid value for each ad request very quickly. For instance, a DSP may determine a bid value in milliseconds for potentially millions of bids per second.

Unfortunately, many of the requests processed by a DSP are fraudulent. The prototypical genuine bid request is transmitted as the result of a user viewing a page on a website or an advertising-enabled app on a mobile device. In contrast, the prototypical fraudulent request is transmitted based on an action taken by a program configured to access a webpage or advertising-enable app. For instance, a content publisher may attempt to increase advertisement income by simulating web traffic to the publisher's website. Processing each bid requests requires substantial computing resources, and substantively evaluating fraudulent bid requests wastes these scarce resources. Further, placing and winning a bid on a fraudulent request directly wastes money since ads are intended for consumption by live users rather than programs. Therefore, detecting and discarding fraudulent bid requests both avoids wasteful expenditure of advertising budgets and conserves both scarce computing resources at the DSP. Moreover, techniques for quickly discarding fraudulent bid requests can improve the functioning of the DSP system to allow greater throughput per server.

One type of fraud that is exceptionally difficult to catch includes requests generated by bot users that suddenly appear, cause the transmission of many requests in a short period of time, and then disappear. For example, a bot may present with a user identifier never before observed in the system and then appear to browse thousands of web pages each minute, leading to one or more advertisement requests for each page. Because human beings do not view thousands of web pages per minute, such bots would be easy to detect if the system could simply count the number of bid requests per user and block users associated with requests that exceed the rate generated by a human being. However, because the handling of bid requests may be divided over hundreds of servers and because hots frequently appear and disappear within minutes, offline methods such as constructing a blacklist (e.g., via Hadoop) that is shared among the servers are too slow to be effective at catching many of these hots.

Techniques and mechanisms described herein facilitate the identification of such hots. According to various embodiments, request servers may employ a probabilistic data structure known as a “sketch” which allows the determination of an approximate answer to a particular computing question rather than an exact answer. In exchange for this loss of exactness, a sketch may require fewer computing resources, less computing time, and/or less storage space to compute, transmit, and/or maintain than an equivalent exact data structure. In particular embodiments, techniques and mechanisms described herein may employ a sketch that uses constant space at the expense of potentially over-counting some events due to hash collisions.

In general, many DSPs are willing to hid little or nothing on requests associated with a relatively new user identifier because little information about the user identifier is available. However, hots that are in operation for a lengthy period of time can be identified as bots via various types of analysis techniques. One way in which bot developers attempt to overcome these challenges is to create bots that suddenly appear and transmit many requests in a short period of time to establish a record for a user identifier without allowing sufficient time to pass so that the bot is identified as such. In particular embodiments, techniques and mechanisms described herein may render many hots unprofitable by identifying such hots within seconds or minutes.

According to various embodiments, techniques and mechanisms described herein may provide any or all of several advantages when compared with conventional detection services. First, techniques and mechanisms described herein may in some implementations incorporate into the analysis all or virtually all requests received and/or processed by the demand-side platform. Second, techniques and mechanisms described herein may provide for extremely rapid detection of a newly observed hot. Empirical analysis suggests that in some instances a demand-side platform may receive hundreds of thousands of fraudulent requests per second, and that a sizeable portion of these (e.g., about 50%) may be generated by hots that have appeared in the last 15 minutes. In some implementations, techniques and mechanisms described herein may facilitate the detection of hots within seconds or minutes. Third, techniques and mechanisms described herein may in some implementations identify a sizable percentage of incoming requests. Empirical analysis suggests that in some instances such techniques and mechanisms may identify approximately 5-10% of incoming requests as fraudulent. Fourth, techniques and mechanisms described herein may in some implementations be easily scalable in that performance does not significantly degrade with each additional server added to the system.

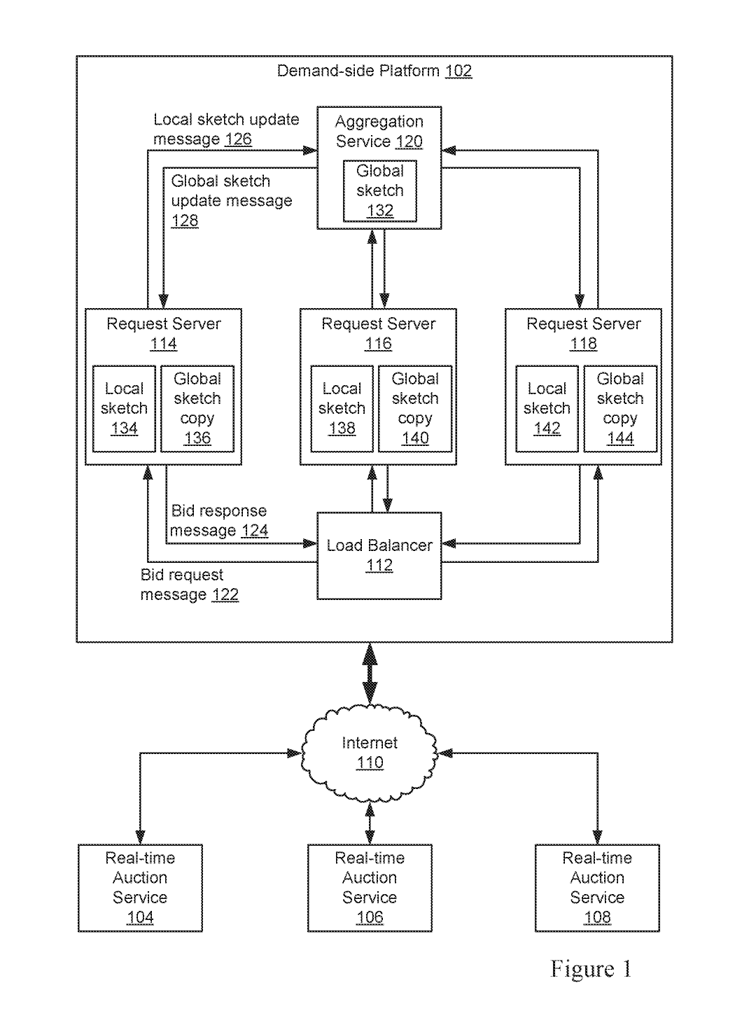

FIG. 1 illustrates an example of a bid request processing system, configured in accordance with one or more embodiments. In the example bid request processing system shown in FIG. 1, a demand-side platform 102 communicates with real-time auction services 104, 106, and 108 through the internet 110. When a client device visits an advertising-enabled page, the right to place an advertisement on the page is auctioned by one of the real-time auction services. The real-time auction service auctioning the right transmits an advertising opportunity bid request to a demand-side platform such as the platform 102. Each demand-side platform that receives the request then has an opportunity to bid on the advertising opportunity, with the winner having the right to place the advertisement.

According to various embodiments, the demand-side platform includes request servers 114, 116, and 118, a load balancer 112, and an aggregation service 120. The load balancer 112 may receive bid requests transmitted via the internet and then route each request to a request server for processing. For instance, the load balancer 112 may receive the bid request message 122 and route it to the request server 114. If the request server 114 makes a determination to bid on the request, then the request server 114 may transmit a bid response message such as the message 124. The load balancer 112 may then transmit the response message back to the real-time auction service via the internet 110.

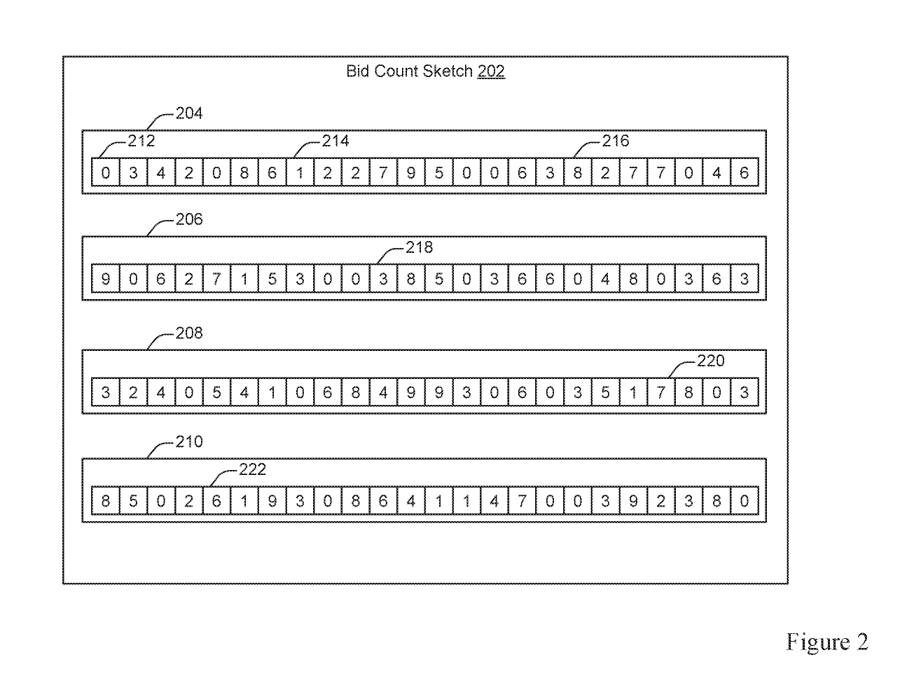

In some implementations, the request server 114 maintains probabilistic data to facilitate the identification of fraudulent request messages. This data includes a local sketch 134 and a global sketch copy 136 at the request server 114, a local sketch 138 and a global sketch copy 140 at the request server 116, and a local sketch 142 and a global sketch copy 144 at the request server 118. The request server 114 is in communication with the aggregation service 120, which maintains a global sketch 132. In this configuration, the local sketch 134 includes information that reflects bid requests received at the request server 114, while the global sketch 132 includes information that reflects bid requests received across multiple request servers, such as each of the request servers 114, 116, and 118. The global sketch copy 136 is a copy of the global sketch 132 that is maintained locally at the request server 114. An example of a sketch is discussed in further detail with respect to FIG. 2.

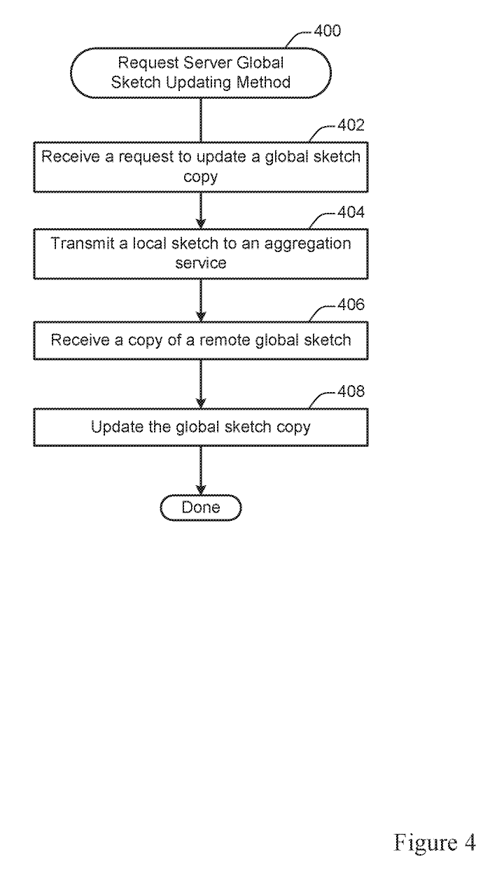

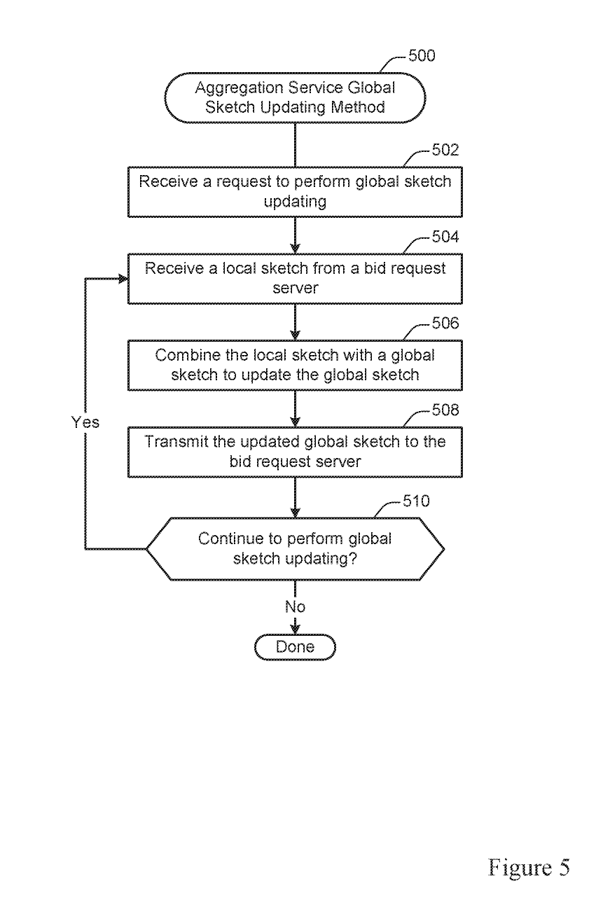

In some embodiments, the request server 114 may update the local sketch 132 based on a bid request message such as the request message 122. The request server may then periodically or at scheduled times transmit a local sketch update message such as the message 126 to the aggregation service 120. The aggregation service 120 may update the global sketch 136 based on the local sketch update message 126. The aggregation service 120 may periodically or at scheduled times transmit a global sketch update message 128 to the request server 114. The global sketch update message 128 may include information for updating the global sketch copy 136 at the request server. Procedures for updating a global sketch at a request server and an aggregation service are discussed with respect to FIGS. 4 and 5.

In some embodiments, the aggregation service 120 may be implemented on a single device, such as a server. Alternately, the aggregation service 120 may be implemented in a decentralized fashion. For example, servers (e.g., request servers or others) may be organized in a hierarchical or tree-like fashion, which each interior node of the tree being responsible for performing aggregation functions for lower levels in the hierarchy. As another example, request servers may be organized into groups, with each group reporting to a different aggregation service.

According to various embodiments, the request server 114 may use the global sketch copy 136 to determine whether a bid request message is fraudulent. In particular, the global sketch copy 136 may be used to provide an estimate regarding how many times a particular user identifier has been observed in association with a request across multiple request servers.

According to various embodiments, an advertisement ecosystem may have various numbers and types of components. For instance, although three real-time auction services are shown in FIG. 1, an advertisement ecosystem may include any number of such auction services. Similarly, the example demand-side platform 102 shown in FIG. 1 includes three request servers for purposes of illustration, but many demand-side platforms may include hundreds of such request servers.

FIG. 2 illustrates an example of a bid count sketch 202, arranged in accordance with one or more embodiments. According to various embodiments, the bid count sketch 202 may be represented as an array. The bid count sketch 202 includes a number of different hash data value rows, including the rows 204, 206, 208, and 210. Each hash data value row corresponds to a different hash function. For example, each hash data value row may correspond to a different seed value associated with a SHA-1 hash function. As another example, each hash data value row may correspond to an entirely different hash function, such as SHA-1, MD5, Rabin-Karp, etc.

In some embodiments, each hash data value row includes a number of hash data values, such as the values 212, 214, 216, 218, 220, and 222. Each hash data value entry is associated with a possible output value from the hash function. For example, the hash data value entry 212 is associated with the hash output value “0” that may be produced by applying the hash function associated with the hash data value row 204 to an input value. As another example, the hash data value entry 222 is associated with the hash output value “4” that may be produced by applying the hash function associated with the hash data value row 210 to an input value.

According to various embodiments, the hash functions may differ in that the same input value provided to the different hash functions is highly likely to produce a different result. For example, hashing a designated user identifier with each of the four hash functions that correspond to the hash data value rows in FIG. 2 may produce an output value of “7” for the first hash function, “10” for the second hash function, “20” for the third hash function, and “4” for the fourth hash function. These values may correspond to the hash data value entries 214, 218, 220, and 220 shown in FIG. 2.

In some implementations, a hash data value may indicate a number of times that an associated hash output value has been produced. For example, the hash data value 214 shown in FIG. 2 is “1”, indicating that the hash function corresponding to the data row 204 has produced an output value of “7” once before. As another example, the hash data value 218 is a “3”, indicating that the hash function corresponding to the data row 206 has produced an output value of 10 a total of three times before.

According to various embodiments, the bid count sketch may be updated for a request message by applying the hash function to the user identifier associated with the request message to produce an output value for each hash function. Then, the hash data value associated with the hash function and the hash output value may be incremented. For instance, if a new message is associated with a user identifier that when hashed with the hash function associated with data row 208 produces an output value of 20, then the value of “7” stored in the hash data value entry 220 may be incremented to “8”.

In some embodiments, the bid count sketch may be used to determine an estimate of a total number of times that a user identifier has been observed in the past. For instance, in FIG. 2, suppose for the purpose of illustration that hashing a designated user identifier with each of the four hash functions that correspond to the hash data value rows in FIG. 2 produces an output value of “17” for the first hash function, “10” for the second hash function, “20” for the third hash function, and “4” for the fourth hash function. The existing hash data values associated with each of these hash output values are “8”, “3”, “7”, and “6”. Thus, the system can determine that the designated user identifier has been observed not more than three times in the past because otherwise the second hash output value would be greater than “3”. Hence, the estimate for the number of times that the user identifier has been observed in the past may be determined by calculating a minimum of the hash data values associated with the hash output values produced by applying the hash functions to the designated user identifier.

In some implementations, a request server may maintain a local copy of a bid count sketch in order to track the number of times a user identifier has been observed at the request server. However, the request server may transmit the local copy of the bid count sketch to an aggregation service so that the aggregation service can combine the local copy with other local copies received from other request servers to produce a global copy. This global copy may reflect user identifiers associated with messages received by all of the different request servers. Thus, the request server may use a local copy of the bid count sketch to record the number of times that user identifiers have been observed at the request server but may instead use a local copy of the global bid count sketch to evaluate incoming request messages. In this way, the request server may determine whether an incoming request is fraudulent based on information aggregated across potentially many different request servers.

In particular embodiments, the error rate may be modeled by the statement that X% of the time, the estimate of the number of previous times that a user identifier was observed is within Y% of the actual number of previous times that the user identifier was observed. Under this definition, Y may be defined as the error of the estimate divided by the total number of requests processed by the system. In some instances, increasing the number of hash functions may decrease the value of X, while increasing the number of hash function output values may decrease the value of Y. In particular, in some implementations the number of hash functions is proportional to ln (1/X), while the number of hash function output values is proportional to (e/Y). In one example, the sketch is configured to occupy a total of 40 MB of memory and employs five hash functions with a total of 8 MB of hash output values for each hash function. In this example, the sketch provides an estimate that is within 5% of the true value over 95% of the time.

According to various embodiments, various numbers of hash functions and hash data values may be used. In general, the error rate of the system may increase as the number of requests processed by the system increases. In contrast, the error rate of the system may decrease as the number of hash data values increases or the number of hash functions increases because increases along either dimension may reduce the frequency of hash collisions. Thus, in some implementations the number of hash functions and hash data values may be strategically determined based on factors such as the desired error rate, various computing requirements or networking constraints, and the number of requests processed by the system.

In some embodiments, a modeling procedure may take as an input parameters such as a desired error rate (e.g., X in paragraph [0046]) and a desired error bound (e.g., Y in paragraph [0046]) and empirically determine output parameters such as a number of hash functions to use and/or a number of output values for each hash function. Such a procedure may process incoming requests and then evaluate the accuracy of the estimates produced with a given set of parameters.

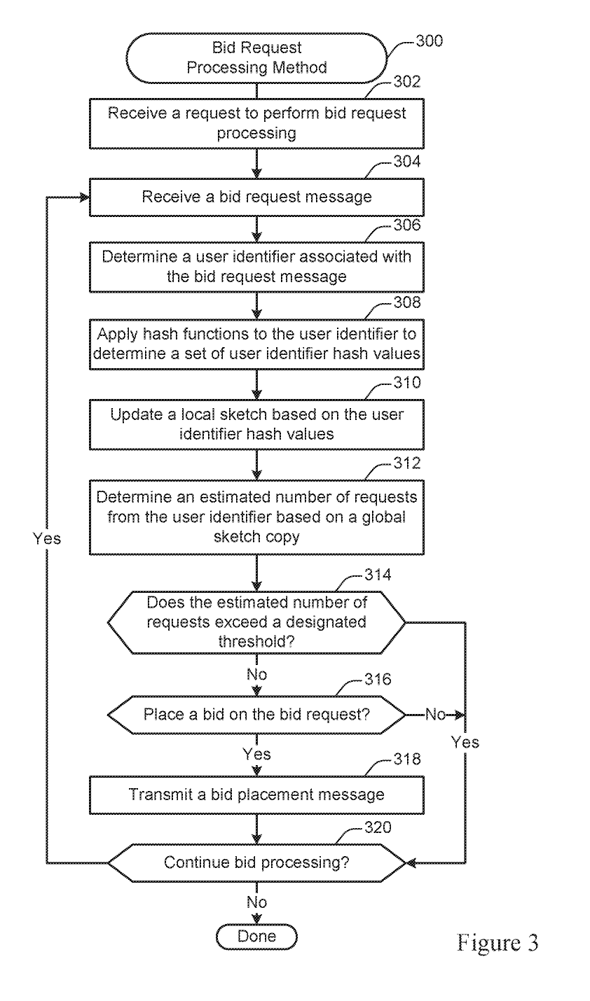

FIG. 3 illustrates an example of a bid request processing method 300, performed in accordance with one or more embodiments. According to various embodiments, the method 300 may be performed at a request server such as the request server 114 shown in FIG. 1.

At 302, a request to perform bid request processing is received. The request to perform bid request processing may be received as part of an initialization routine at the request server 114. For instance, the request to perform bid request processing may be generated as part of server startup or may be received from a control system associated with the demand-side platform.

At 304, a hid request message is received. An example of a bid request message is discussed with respect to the message 122 shown in FIG. 1. In some embodiments, the bid request message may include information capable of being used by the bid request server to determine whether to place a bid. For instance, the bid request message may be received from a real-time auction service such as the service 104 shown in FIG. 1. The bid request message may include any of various types of information, such as a user identifier or information indicating a context associated with the request. For instance, the bid request message may indicate an advertising-enabled application or website at which an advertisement is to be presented.

At 306, a user identifier associated with the bid request message is determined. According to various embodiments, a user identifier may be determined in various ways depending on factors such as the information included in the bid request message. For example, the bid request message may include a user identifier provided by the demand-side platform, such as when the demand-side platform has previously provided a device associated with the bid request with a web cookie that includes the unique identifier. As another example, the bid request message may include an identifier provided by a third-party site. In such a situation, the request server may determine a user identifier by using the third-party identifier directly or by determining a correspondence between the third-party identifier and a demand-side platform identifier. As yet another example, the bid request message may fail to include any recognizable user identifier. In such a situation, the request server may determine a user identifier by directly employing or by modifying (e.g., hashing) any of various identifying information associated with the request. For instance, the request server may determine a user identifier by combining, directly using, or hashing an Internet Protocol (IP) address and/or browser user agent string associated with the bid request.

At 308, hash functions are applied to the user identifier to determine a set of user identifier hash values. At 310, a local sketch is updated based on the user identifier hash values. According to various embodiments, a number of different hash functions may be applied to the same user identifier to produce a number of different hash output values. Then, function-specific count values associated with each of these hash output values may be updated by incrementing each function-specific count. Additional details regarding the application of hash functions to the user identifier and the updating of a local sketch were discussed with respect to FIG. 2.

At 312, an estimated number of requests from the user identifier is determined based on a global sketch copy. In some embodiments, the estimated number of requests may be determined by using the hash output values to first determining a set of function-specific counts associated with a copy of a global sketch that represents an aggregation of potentially many different local sketches. These function-specific counts may then be combined to produce the estimate. For instance, a minimum of the function-specific counts may be determined. Alternately, a different technique may be used to combine the function-specific counts, such as determining a weighted average. The application of hash functions to the user identifier was discussed in additional detail with respect to FIG. 2.

At 314, a determination is made as to whether the estimated number of requests exceeds a designated threshold. According to various embodiments, the sketches may be maintained in a rolling manner so that the global sketch provides information on request messages received in a designated period of time such as the last five minutes, thirty minutes, or hour. The designated threshold may be determined in any of a variety of ways. In a first example, the designated threshold may be specified as a number of request messages received in the designated period of time, such as 5,000 messages per hour. In a second example, the designated threshold may be specified as a deviation from the mean. For instance, a message with an identifier associated with a number of requests that exceeds the mean number of requests per identifier by a factor of 0.95 may be discarded. In a third example, the designated threshold may be determined based on statistical modeling. For instance, the sketch may be periodically analyzed to determine a break point past which a request is likely to be fraudulent.

In particular embodiments, the selection of a conservative threshold may allow for legitimate bursts of requests from real users. For instance, a form of bidding referred to as header bidding by publishers may generate request from the same user via multiple auction services within a short window of time.

At 316, a determination is made as to Whether to place a bid on the bid request when it is determined that the request is not fraudulent. In some embodiments, the determination as to whether to place a bid may be based on any or all of a variety of considerations. For example, a bid request message may be analyzed to match the request message with a designated advertising campaign. As another example, the bid request message may be analyzed to estimate the likelihood that an advertisement impression would result in a conversion. As yet another example, the bid request message may be analyzed to determine an amount of money to bid on the advertisement impression.

At 318, a hid placement message is transmitted when it is determined to bid on the opportunity. According to various embodiments, the hid placement message may include information such as an identifier for the bid request message and an amount to bid on the advertisement impression. The bid placement message may be transmitted back to the real-time auction service, which may aggregate potentially many bids to determine a winner of the advertisement impression. The winner may then be provided with the opportunity to place the advertisement, for instance by transmitting image, text, and/or video data to the device on which the advertisement is to be presented.

At 320, a determination is made as to whether to continue bid processing. According to various embodiments, bid processing may continue until the bid request server is deactivated or until no bid request messages remain for processing. For instance, a central control service for the demand-side platform may deactivate a request server when bid request volume falls below a threshold.

FIG. 4 illustrates an example of a request server global sketch updating method 400, performed in accordance with one or more embodiments. According to various embodiments, the method 400 may be performed at a request server such as the request server 114 shown in FIG. 1.

At 402, a request to update a global sketch copy is received. The request to update a global sketch copy may be generated periodically, at scheduled times, or in response to a triggering event. For example, the global sketch copy may be updated once per minute. As another example, the global sketch copy may be updated when a designated number of bid requests have been received.

At 404, a local sketch is transmitted to an aggregation service. According to various embodiments, the local sketch may be transmitted to the aggregation service via a local sketch update message such as the message 126 shown in FIG. 1. The local sketch update message may include any information suitable for providing an updated version of the local sketch 134 to the aggregation service 120. For example, the local sketch update message may include the entire local sketch 134. As another example, the local sketch update message may include a difference between the current version of the local sketch 134 and a previous version of the local sketch 134, such as the additions that have occurred in the time since the previous version of the local sketch 134 was transmitted to the aggregation service.

At 406, a copy of a remote global sketch is received. In some implementations, the copy of the remote global sketch may be received via a global sketch update message such as the message 128 shown in FIG. 1. The global sketch update message 128 may include any information suitable for updating a local copy of the global sketch at the request server such as the global sketch copy 136 at the request server 114 shown in FIG. 1. For example, the global sketch update message 128 may include a complete copy of the global sketch 132 or may include a difference between the current version of the global sketch 132 and a different version of the global sketch 132 that was previously sent to the request server 114.

At 408, the global sketch copy is updated. According to various embodiments, updating the global sketch may involve any operations necessary for ensuring that the local copy of the global sketch reflects information from across the different request servers. For instance, the global sketch copy 136 may simply be replaced with a version sent from the server in the global sketch update message. Alternately, a difference sketch sent from the server may be added to an existing global sketch copy in order to update the global sketch copy at the request server. In particular embodiments, the global sketch copy may be updated by performing an addition and a subtraction. For instance, the most recent global sketch transmitted from the server may be added to the global sketch copy retained at the request server, while a previous iteration of the global sketch transmitted from the server may be subtracted from the global sketch copy retained at the request server.

FIG. 5 illustrates an example of an aggregation service global sketch updating method 500, performed in accordance with one or more embodiments. According to various embodiments, the method 500 may be performed at an aggregation service such as the aggregation service 120 shown in FIG. 1.

At 502, a request to perform global sketch updating is received. In some embodiments, the request to perform global sketch updating may be performed as part of the startup operations of the aggregation service. Alternately, the request to perform global sketch updating may be generated by a system administrator or provided programmatically by a demand-side platform control system.

At 504, a local sketch is received from a bid request server. According to various embodiments, the local sketch may be received as part of a local sketch update message such as the message 126 shown in FIG. 1. The local sketch update message may be generated as described with respect to operation 404 shown in FIG. 4.

At 506, the local sketch is combined with a global sketch to update the global sketch. Depending on the implementation, various approaches to combination may be used. In particular embodiments, combining a local sketch with a global sketch may involve adding the values in the local sketch with the corresponding values in the global sketch. For instance, the local sketch may include a hash count value associated with a designated hash function and a designated hash value. The hash count value may indicate a number of times that the application of the designated hash function to a user identifier associated with a request message has produced the designated hash value. The hash count value associated with the local sketch may be added to the hash count value associated with the global sketch to produce an updated hash count value for the global sketch. This process may be applied across all hash count values to produce an updated global sketch.

In particular embodiments, the server may divide the sketch into increments of a designate period of time, such as one minute. Then, the server may incorporate a windowed period of time, such as three minutes, into the sketch so that outdated information is removed from the sketch. For instance, combining the local sketch with the global sketch may involve adding the local sketch hash values to the global sketch hash values. Then, hash values from a previous version of the local sketch, such as a version from several minutes in the past, may be subtracted from the global sketch hash values to remove the impact of the previous version of the local sketch on the global sketch. In order to accomplish this windowing, the aggregation service may retain some or all of the previous local sketches transmitted from the request server. In various implementations, various approaches to windowing may be employed depending on the desired system parameters. Further, windowing operations such as subtracting previous versions of a sketch may be performed either on the request server or on the aggregation service.

At 508, the updated global sketch is transmitted to the bid request server. According to various embodiments, the updated global sketch may be transmitted to the bid request server as part of a global sketch update message such as the message 128 shown in FIG. 1. The global sketch update message may be generated as described with respect to operation 406 shown in FIG. 4.

In some implementations, the global sketch update message 128 may be transmitted as a direct response to the local sketch update message 126. Alternately, or additionally, the global sketch update message 128 may be transmitted asynchronously or according to a different schedule as the local sketch update message 126. For example, a request server may transmit a local sketch update message once per minute but may receive a global sketch update message 128 at a different frequency, such as once every two minutes. As another example, each request server may transmit local sketch update messages directly to the aggregation service 120, while the aggregation service 120 may periodically broadcast global sketch update messages to multiple request servers.

At 510, a determination is made as to whether to continue to perform global sketch updating. According to various embodiments, global sketch updating may continue to be performed until a request to terminate global sketch updating is received. Such a request may be generated manually by an administrator, automatically by a demand-side platform control system, when the aggregation service 120 is powered down or restarted, or when some other triggering condition is met.

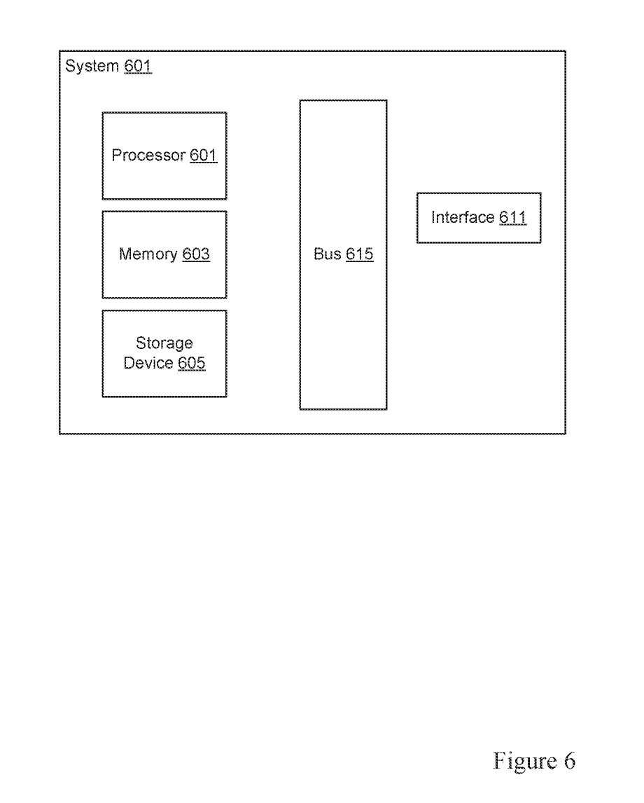

FIG. 6 illustrates one example of a computing device. According to particular embodiments, a system 600 suitable for implementing particular embodiments of the present invention includes a processor 601, a memory module 603, a storage device 605, an interface 611, and a bus 615 (e.g., a PCI bus or other interconnection fabric) and operates as server, client device, or any other device or service described herein. Various specially configured devices can also be used in place of a processor 601 or in addition to processor 601. The interface 611 is typically configured to send and receive data packets over a network. According to various embodiments, devices such as a request server, an aggregation service, or a load balancer may be implemented on a device such as the system 600. The processor 601 may perform operations such as those described throughout this application, an in particular operations described with respect to FIGS. 1, 2, 3, 4, and 5. Instructions for performing such operations may be embodied in the memory 603, on one or more non-transitory computer readable media, or on some other storage device.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. Although a particular server is described, it should be recognized that a variety of alternative configurations are possible.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
receiving a request message via a network interface at a designated request server in a request system, the request system including a plurality of request servers that include the designated request server, the request message being associated with a designated user identifier;
identifying via a processor an estimated message count value associated with the user identifier, the estimated message count value identifying an estimated number of messages associated with the user identifier and previously-received by the plurality of request servers; and
transmitting a response message via the network interface when it is determined that the estimated message count is below a designated threshold.

2. The method recited in claim 1, wherein the request message identifies an opportunity to place a bid on an advertisement impression, and wherein the response message includes advertisement impression bid information indicating a bid to place on the identified advertisement impression bid opportunity.

3. The method recited in claim 2, the method further comprising:
evaluating the request message to determine whether to bid on the advertisement impression when it is determined that the estimated message count is below a designated threshold, wherein the response message is transmitted when a determination is made to bid on the advertisement impression.

4. The method recited in claim 1, wherein determining the estimated message count value comprises determining a plurality of hash values associated with the user identifier, each of the plurality of hash values being associated with a respective hash function.

5. The method recited in claim 4, wherein determining the estimated message count value further comprises identifying a plurality of hash count values, each hash count value associated with a respective hash value and a respective hash function, each hash count value identifying a number of times the respective hash value has been previously computed via the respective hash function.

6. The method recited in claim 5, wherein determining the estimated message count value further comprises combining the plurality of hash count values into a single value.

7. The method recited in claim 6, wherein combining the plurality of hash count values comprises determining a minimum of the plurality of hash count values.

8. The method recited in claim 4, the method further comprising:
updating a plurality of local hash count value totals based on the plurality of hash values.

9. The method recited in claim 8, wherein updating the plurality of local hash count value totals comprises incrementing each local hash count value total that corresponds with a respective one of the plurality of hash values and a respective one of the plurality of hash functions.

10. The method recited in claim 9, the method further comprising:
transmitting a global hash count value update message to an aggregation service, the global hash count value update message including the local hash count value totals.

11. The method recited in claim 10, the method further comprising:
receiving a global hash count value response message from the aggregation service, the global hash count value response message including a plurality of global hash count value totals corresponding with the local hash count value totals, each global hash count value total identifying a number of times that a designated hash value has been determined for a designated hash function across the plurality of request servers.

12. The method recited in claim 11, wherein the estimated message count value identifies an estimated number of messages associated with the user identifier and previously-received by the plurality of request servers within a designated period of time.

13. A system comprising:
an aggregation service; and
a plurality of request servers, each request server comprising:
memory configured to store a request message received at the request server, the request message being associated with a designated user identifier;
a processor configured to identify an estimated message count value associated with the user identifier, the estimated message count value identifying an estimated number of messages associated with the user identifier and previously-received by the plurality of request servers; and
a network interface configured to transmit a response message when it is determined that the estimated message count is below a designated threshold.

14. The system recited in claim 13, wherein the request message identifies an opportunity to place a bid on an advertisement impression, and wherein the response message includes advertisement impression bid information indicating a bid to place on the identified advertisement impression bid opportunity.

15. The system recited in claim 14, wherein the processor is further configured to:
evaluating the request message to determine whether to bid on the advertisement impression when it is determined that the estimated message count is below a designated threshold, wherein the response message is transmitted when a determination is made to bid on the advertisement impression.

16. The system recited in claim 15, wherein determining the estimated message count value comprises determining a plurality of hash values associated with the user identifier, each of the plurality of hash values being associated with a respective hash function.

17. The system recited in claim 16, wherein determining the estimated message count value further comprises identifying a plurality of hash count values, each hash count value associated with a respective hash value and a respective hash function, each hash count value identifying a number of times the respective hash value has been previously computed via the respective hash function.

18. The system recited in claim 17, wherein determining the estimated message count value further comprises combining the plurality of hash count values into a single value, and wherein combining the plurality of hash count values comprises determining a minimum of the plurality of hash count values.

19. The system recited in claim 16,
wherein the processor is further configured to update a plurality of local hash count value totals based on the plurality of hash values, and wherein updating the plurality of local hash count value totals comprises incrementing each local hash count value total that corresponds with a respective one of the plurality of hash values and a respective one of the plurality of hash functions, and
wherein the network interface is further configured to receive a global hash count value response message from the aggregation service, the global hash count value response message including a plurality of global hash count value totals corresponding with the local hash count value totals, each global hash count value total identifying a number of times that a designated hash value has been determined for a designated hash function across the plurality of request servers.

20. One or more computer readable media having instructions stored thereon for performing a method, the method comprising:
receiving a request message via a network interface at a designated request server in a request system, the request system including a plurality of request servers that include the designated request server, the request message being associated with a designated user identifier;
identifying via a processor an estimated message count associated with the user identifier, the estimated message count identifying an estimated number of messages associated with the user identifier and previously-received by the plurality of request servers; and
transmitting a response message via the network interface when it is determined that the estimated message count is below a designated threshold.
